(19) United States
(12) Patent Application Publication
(10) Pub. No.: US 2006/0031219 A1
(43) Pub. Date: Feb. 9, 2006

(54) Method and apparatus for informational processing based on creation of term-proximity graphs and their embeddings into informational units

(76) Inventors: Leon Chernyak, Sharon, MA (US); Arkady Berenstein, Eugene, OR (US)

Correspondence Address: PROSKAUER ROSE LLP, ONE INTERNATIONAL PLACE 14TH FL, BOSTON, MA, 02110, US

(21) Appl. No.: 11/186,249

(22) Filed: Jul. 21, 2005

Related U.S. Application Data
(60) Provisional application No. 60/521,931, filed on Jul. 22, 2004.

(51) Int. Cl. G06F 17/30

(52) U.S. Cl. 707/5

(57) ABSTRACT

A method for processing a document in a set of documents is disclosed comprising the steps of generating a topological search query comprising a set of search terms having a defined interrelationship between at least two of the terms, and generating a non-linear representation for at least one document in the set based on the topological search query, the nonlinear representation representing a measure of at least proximity of the search terms within the document.

### RELATED APPLICATION

This application claims the benefit of U. S. Provisional Application No. 60/521,931, filed on Jul. 22, 2004, the entire contents of which are incorporated herein by reference.

### FIELD OF INVENTION

This invention relates to detection and creation of geometric patterns of term distribution in informational units, and rating and clustering of the informational units for each given set of terms.

### BACKGROUND

Term Extraction Techniques

An existing technique for query refinement involves preparation of a term list on the basis of the occurrence frequency of two terms, i.e., the frequency of two terms co-occurring within a neighborhood of each other in a given document.

In another technique, a document (or a written item) for which a related-term list will be prepared is subjected to morphological analysis, so that the part of speech of each term is determined. Subsequently, functional words are removed from the document, or only the frequencies of content words co-occurring with other terms are aggregated. A related-term list is prepared through such aggregation operations.

In still another technique, on the basis of the frequencies of terms co-occurring with a specified term in a document, terms having high frequencies of co-occurring with the specified term and terms having low frequencies of co-occurring with the specified term are removed during the process of preparation of a related-term list, thus preparing a related-term list.

In yet another technique that has already been put forth, terms having special relationships are determined through syntax analysis, and the frequencies of the thus-determined terms co-occurring with each other are aggregated. A related-term list is prepared through such aggregation operations.

One of the most important objectives of these approaches consists in suggesting to a user of a computer system summary of documents or additional terms for query refinement.

However, the discussed above technologies of term extraction are not very efficient, because of the following problems. One problem with existing techniques for generating related query terms is that the related terms are frequently of little or no value to the search refinement process. Another problem is that the addition of one or more related terms to the query sometimes leads to a NULL query result. Another problem is that the process of parsing the query result items to identify frequently used terms consumes significant processor resources, and can appreciably increase the amount of time the user must wait before viewing the query result. These and other deficiencies in existing techniques hinder the user's goal of quickly and efficiently locating the most relevant items, and can lead to user frustration. The gravity of these problems is reflected in the strategy which many search engines, such as Excite, AltaVista, Yahoo! employ for “search refinement.” Instead of suggesting to the user the results of their analysis of retrieved documents, they typically suggest similar queries memorized from past searches.

Clustering Techniques

Document clustering was originally of interest because of its ability to improve the effectiveness of information retrieval. Standard information retrieval techniques, such as nearest neighbor methods using cosine distance, can be very efficient when combined with an inverted list of word-to-document mappings. These same techniques for information retrieval perform a variant of dynamic clustering, matching a query or a full document to their most similar neighbors in the document database.

The advent of the Internet has renewed interest in clustering documents in the context of information retrieval. Instead of pre-clustering all documents in a database, the results of a query search can be clustered, with documents appearing in multiple clusters. Instead of presenting a user with a linear list of related documents, the documents can be grouped in a small number of clusters, perhaps ten, and the user has an overview of different documents that have been found in the search and their relationship within similar groups of documents.

Document clustering can be of great value for tasks other than immediate information retrieval. Among these tasks are summarization and label assignment, or dimension reduction and duplication elimination.

The most popular ones, among several different techniques for documents clustering, are the classical k-means technique and the hierarchical agglomerative methods. The weaknesses of these methods are well known. While efficient, these approaches have a common weakness of being rather slow. The recently proposed approach of the light weight document clustering (U.S. Pat. No 6,654,739, by Apte et al.) is more time efficient, but only at the expense of relevance.

### SUMMARY OF THE INVENTION

The present invention features techniques for performing term extraction, clustering, and ranking of documents based on a novel method of representing a document in the context of search term relevancy.

According to one embodiment, a method and apparatus for processing a document in a set of documents comprises the step of generating a discrete topological search query comprising a set of search terms having a defined interrelationship between at least two of the terms. Based on this topological search query, a non-linear representation for at least one document in the set is generated in which the nonlinear representation represents a measure of at least proximity of the search terms within the document. Information in the non-linear representation of a corresponding document can be used to generate a ranking value for that document. Information in the non-linear representation of a corresponding document can also be used to generate a refined discrete topological search query by extracting new terms. Information in at least two or more non-linear representations of corresponding documents can be used to generate a cluster of the documents.

In a particular embodiment, a method and apparatus is provided for efficiently and automatically self-tuning a system for documents processing, clustering, summarizing, and query enhancing.

In the particular embodiment, the method transforms queries into term-proximity graphs, embeds the term-proximity graph into each informational unit. Based on this procedure of embedding, the method equips the embedded graph with a metric, i.e., assigns certain values to the edges.

Based on such metrization, the method proceeds with geometrization of the term-proximity graph itself. In this way the relevancy context is established for each informational unit. Creation of the geometric relevancy context allows for the efficient extraction of relevant information (e.g., as summaries, extracted terms, new queries) and for organization of large collections of informational units (e.g., clustering, ranking, ordering). All this is achieved due to the transformation of such linear entities as informational unit (e.g., documents) into such non-liner entities as the geometrized term-proximity graphs.

Specifically, the method further processes informational units based on their respective geometrized term-proximity graphs, performs the initial geometric ordering of informational units based on their total potentials relative to their respective geometrized term-proximity graphs, saturates with new terms the geometrized term-proximity graphs based on their geometric affinity to term distribution within the respective informational units, detects terms in the saturated geometrized term-proximity graphs and, based on the detection, condenses the graphs. Subsequently, the method proceeds with the further ordering of the informational units into thematic clusters based on the saturated geometrized term-proximity graphs; and, ultimately, based on all the above, it enhances and refines the original term-proximity graph and the original query.

In another particular embodiment, a method of graphic/geometric organization of words of a query and of relevant informational units is provided comprising the steps of: creating a term-proximity graph design out of the words of query; establishing and managing the edges of the term-proximity graph; topologically embedding the term-proximity graph into an informational unit; metrizing each topologically embedded term-proximity graph; generating a geometrized term-proximity graph for each informational unit based on the metrized term-proximity graph topologically embedded into the informational unit; processing the informational units based on their respective geometrized term-proximity graphs; ordering the informational units based on a total potential relative to their respective geometrized term-proximity graphs; term-saturating the geometrized term-proximity graphs based on a geometric affinity to the term distribution within the respective informational units; condensing the geometrized term-proximity graphs based on term detection; ordering the informational units into at least one thematic cluster based on the saturated metrized embedded term-proximity graphs; and enhancing and refining the original term-proximity graph and the original query based on the geometric correlation between saturated geometrized term-proximity graphs of the informational units. Transformation of each query into the term-proximity graph Γ can involve placing the words of the query at vertices of Γ and assigning to each vertex W of Γ a non-negative integer mult(W) which is to be further referred to as the multiplicity of W. Each edge of the term-proximity graph Γ can be defined as an ordered pair (W, W′) of the query words W and W′ with a multiplicity mult(W, W′) which can be a positive integer (and if (W, W′) is not an edge, it can be assumed that mult(W, W′)=0). A vertex of the term-proximity graph topologically embedded into an informational unit D can be an i-th occurrence (W, i) of a query word W in D (to be further referred as a query word W nested in D). An edge of the term-proximity graph topologically embedded into an informational unit D can be a pair ((W,i), (W′j)), where (W, i) is an i-th occurrence of a query word W in D and (W′j) is aj-th occurrence of a query word W′ in D, and where the pair (W,W′) is an edge of the original term-proximity graph. The topologically embedded term-proximity graph can be metrized by assigning a value to each edge ((W,i), (W′j)). The value assigned to each edge ((W,i), (W′j)) of metrized embedded term-proximity graph can be a function of the distance between the query words (W,i) and (W′j) nested in the informational unit D. The distance dist(U, U′) between two words U and U′ in the informational unit D can be defined as a function of the number of words and of the number of sentences separating U and U′ in D. The distance between two words U and U′ in the informational unit D can be defined by he formula
dist(U, U′)=ƒ(N+1).g(M+1),
where N is the number of words in D separating U and U′, M is the number of sentences in D separating U and U′, andƒ(x), g(x) are any functions the real variable x such that ƒ(x)>0 and g(x)>0 if x>0. The function ƒ(x) and the function g(x) can be given by ƒ(x)=x^{k} and g(x)=x^{l} for each x>0, where k and l are non-negative numbers, e.g., ƒ(x)=1 or ƒ(x)=x or ƒ(x)=x², and g(x)=1 or g(x)=x or g(x)=x². For generation of the geometrized term-proximity graph relative to a given informational unit D wherein geometrization can proceed by assigning masses to vertices and local potentials to the edges of the original term-proximity graph. The mass mw of a vertex W of the term-proximity graph relative to the informational unit D can be defined as a function of a certain frequency characteristic of the query word W in D. The mass mw of a vertex W of the term-proximity graph relative to the informational unit D can be defined as the number of occurrences of the query word W in D. The mass mw of a vertex W of the term-proximity graph relative to the informational unit D can be defined as the number of those sentences of D in which the query word W occurs. The mass mw of a vertex W of the term-proximity graph relative to the informational unit D can be defined as the number of those paragraphs of D in which the query word W occurs. The local potential of a given informational unit D relative to an edge (W, W′) of the term-proximity graph can be defined as a function of the lengths of a subset of edges of the metrized embedded term-proximity graph, where the length of an edge ((W,i), (W′j)) can be defined as the distance dist((W,i), (W′j)). The subset of edges of the metrized embedded term-proximity graph can consist of all edges of the graph. The subset of edges of the metrized embedded term-proximity graph can consist of all reduced edges of the graph, where an edge ((W,i), (W′j)) can said to be reduced if neither W nor W′ occurs in the informational unit between the words (W,i), (W′j). The subset of edges of the metrized embedded term-proximity graph can consist of all directed edges of the graph, where for a given edge (W, W′) of the original term-proximity graph an edge ((W,i), (W′j)) in the metrized embedded term-proximity graph can said to be directed if W precedes W′ in D. The subset of edges of the metrized embedded term-proximity graph can consist of all those edges which are both directed and reduced. The local potential P_{(W,W′)}(D) of a given informational unit D relative to an edge (W,W′) of the original term-proximity graph can be given by the formula
P_{(W,W′)}(D)=Σh(dist((W,i), (W′j))),
where the summation is over selected subset of edges of the metrized embedded term-proximity graph based on query words W and W′, where h(x) can be any function of the real variable x such that h(x)>0 if x>0. The function h(x) can be given by h(x)=x^{-k} for each x>0, where k can be a positive number (e.g., h(x)=1/x or h(x)=1/x²). The total potential P(D) of an informational unit D can be defined as a function of the term-proximity graph geometrized relative to D. The total potential P(D) of an informational unit D can be defined as a function of all of the following: the masses and multiplicities of the vertices, the local potentials and multiplicities of edges of term-proximity graph geometrized relative to D. The total potential P(D) of an informational unit D can be defined by the formula
P(D)=Σ_{w} mult(W).F(m_{w})+Σ_{(w,w′)}mult(W,W′).P_{(w,w)}(D),
where the first summation can be over the all vertices of the term-proximity graph Γ(i.e., over all words of the query) and the second summation can be over all the edges of Γ, and where F(x) can be any function of the real variable x such that F(x)>0 if x>0. The function F(x) can be given by F(x)=x^{k} for each x>0, where k can be a real number (e.g., F(x)=1, or F(x)=1/x, or F(x)=x²). Term-saturation of the geometrized term-proximity graph can proceed as the attraction of terms from vicinities of specially selected edges of the metrized embedded term-proximity graph to the geometrized term-proximity graph of a given informational unit. The vicinity of a given edge ((W,i),(W′j)) of the metrized embedded term-proximity graph in a given informational unit D can be an interval of D containing both words (W,i) and (W′j). The vicinity of a given edge ((W,i),(W′j)) of the metrized embedded term-proximity graph in a given informational unit D can be the interval of D between the words (W,i) and (W′j). During term-saturation of the geometrized term-proximity graph, the specially selected edges of the metrized embedded term-proximity graph can be those edges which have the minimal possible value among all edges of the graph. During term-saturation of the geometrized term-proximity graph, the specially selected edges of the metrized embedded term-proximity graph can be those edges ((W,i),(W′j)) on which the minimum of the distance function dist((W,i),(W′j)) is reached. Further term-saturation can proceed as an incorporation of a subset of the attracted terms into the geometrized term-proximity graph. During term-saturation of the geometrized term-proximity graph, the incorporation of the attracted terms into the graph can be defined as adding the attracted terms as vertices of the graph and connecting them with each other and with existing vertices of the graph by edges equipped with newly computed local potentials. The condensation of the term-saturated geometrized term-proximity graph can proceed as the contraction of certain edges into vertices of the graph, where the each procedure of contraction can consist of replacing a set of edges of a graph with a single vertex while keeping other edges of the graph. The contraction of an edge (W,W′) can be comprised of replacing the edge with a single vertex containing the compound term WW′, while the mass of this new vertex is calculated and other edges along with their local potentials are updated. The contraction can comprise of the following steps: The algorithm modifies the graph r as follows: it can replace the edge the edge (W,W′) by a single vertex WW′ while the multiplicity mult(WW′) and the mass_{ww′} can be assigned to the new vertex WW′ by the formulae:
mult(WW′)=mult(W)+mult(W′)+mult(W,W′) m_{ww′}=min(m_{w}, m_{w′})
and the multiplicity mult(WW′, W″) and the potential P_{(ww′, w″)} can be assigned to each edge originated in the new vertex WW′ by the formulae:
mult(WW′, W″)=mult(W,W″)+mult(W′,W″) P_{(WW′, W″)}=max(P_{(W,W″)},P_{(W′,W″)})
for any other vertex W′ of the geometrized term-proximity graph. Geometric ordering of informational units into thematic clusters can be based on the evaluation of geometric correlation between the term-saturated geometrized term-proximity graphs of various informational units. The vertices and edges may be added to or deleted from the graph based on the overall geometric correlation between the term-saturated geometrized term-proximity graphs of informational units within a given cluster for enhancement and refinement of the original term-proximity graph and the original query. Each term-proximity graph can be represented graphically on the screen of the computer. Each term-proximity graph can be represented as a list of pairs of the keywords. Each term-proximity graph can be represented as a square matrix on the screen of the computer. Each term-saturated geometrized term-proximity graph can be represented on the screen of the computer in such a way that the masses are marked on the vertices and the local potentials are marked on the edges. Each term-saturated geometrized term-proximity graphs can be represented as a list of pairs of the keywords with their masses and respective local potentials on the screen of the computer. Each term-saturated geometrized term-proximity graphs can be represented as a square matrix along with the masses and local potentials on the screen of the computer. Each term-saturated geometrized term-proximity graph can be represented along with the respective informational unit on the screen of the computer. Each change in a given informational unit can trigger an update of the attached tern-saturated geometrized term-proximity graph.

### BRIEF DESCRIPTION OF THE DRAWINGS

FIG. 1 is a flow chart of a mathematical procedure that represents the embodiments of the invention.

FIG. 2 presents three embodiments of methods for creating and representing term-proximity graphs.

FIG. 3 is a flow chart representing a procedure for embedding a term-proximity graph into a document and metrization of so embedded graph.

FIG. 4 is a flow chart representing a procedure for geometrizing the term-proximity graph and calculating the total potential of the geometrized term-proximity graph.

FIG. 5 represents a procedure for term-saturation of the geometrized term-proximity graph.

FIG. 6 represents a procedure for term-detection and condensation of the geometrized term-proximity graph.

FIG. 7 represents a procedure of the routine of FIG. I for clustering the documents and enhancing the term-proximity graph and the query.

FIGS. 8A-8E is an example of a method for generating a nonlinear representation for a document D given a query Q.

FIG. 9 shows the internal structure of a digital computer to which embodiments of the invention can be applied.

### DETAILED DESCRIPTION

The present invention features efficient processing of large document collections, ranking these documents based on relevancy, thematically clustering these documents, and, based on this, for construction of summaries of documents and their clusters, and for generation of enhanced and refined queries. According to one embodiment, a mathematical graph is created to represent the relevancy of, on the one hand, a document to a query or, on the other hand, a mutual relevancy of documents to one another with regard to a query, which may be a geometric term-proximity graph in one embodiment as described below, that, while providing and surpassing all of the advantages of existing methods for documents-processing, ranking, and clustering, at the same time bypasses all of the inconveniences and difficulties associated with the existing approaches.

According to one embodiment, relevancy contexts as represented by geometric patterns of term distribution in each document are established as well as the establishment of mutual geometric affinity between these representations. The latter may be between the geometric patterns of the query and the geometric representations of each document, and may be between the representations of the documents themselves. Because of this automatic relevancy context creation, the method of term-proximity graphs of the system hereof allows for an extremely efficient processing, ranking, and clustering of documents.

Embodiments of the present invention may proceed from the assumption that the meaning of each retrieved document depends on the query by which the document has been retrieved, i.e. the meaning depends on the embedding of the query into the document. The same document can reveal two different meanings corresponding to two different queries or to the same query but organized in two different ways.

Embodiments of the invention include, but are not limited to, retrieval, pre-processing, ranking, clustering, and distribution of information on the Internet, intranets, databases, or even any information recording medium used by a local computer. In particular, the present invention can provide extensive support for indexing the World Wide Web for large search engines such as Google, Yahoo! and MSN.

Embodiments of the present invention can involve creating a non-linear geometric representation of a linear string of symbols of an informational unit. A typical informational unit is a document. Symbols can include, but are not limited to, any set of ASCII characters or their equivalent, or any graphical symbol used in an informational unit, e.g. ® or §. In one embodiment, the non-linear geometric representation created is a geometrized term-proximity graph, which mathematically carries a structure of a topological or metric space and which provides the proper context for extraction and measurement of information contained in the informational unit. One particular piece of information that is measured is a ranking value, given the term total potential, of the geometrized term-proximity graph, described below.

Embodiments of the present invention can utilize such mathematical and physical theories as Graph Theory, Harmonic Analysis, and Potential Theory. Such embodiments represent the first application of these physical theories in the fields of processing, ranking, and clustering of documents.

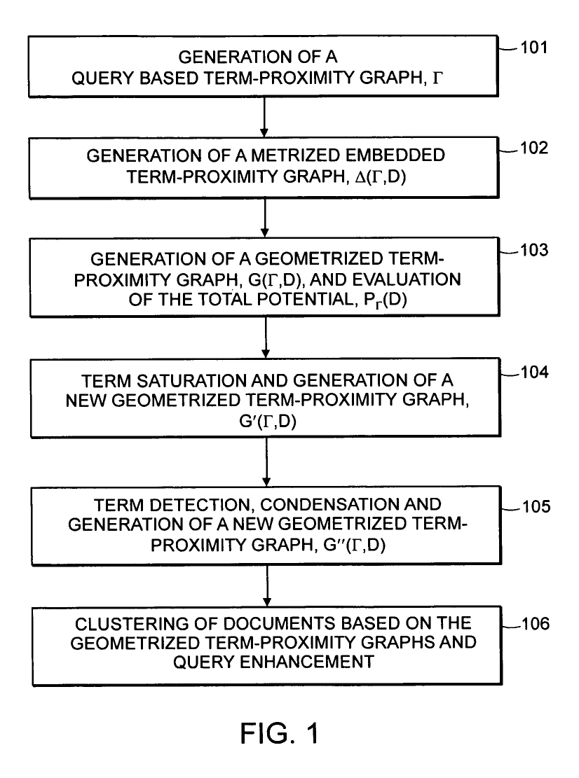

An exemplary method for achieving the aforementioned benefits is depicted in the flow chart in FIG. 1, and is described as follows.

Step 101 represents the generation of a term-proximity graph Γ from a query, in which the expected proximity of terms may be explicitly assigned. Mathematically, the term-proximity graph Γ is an example of a discrete topology.

Step 102 represents the first step in the processing of any document D with regard to the query, and proceeds for each document separately. A term-proximity graph Γ is geometrically embedded and metrized into a document D, generating a metrized embedded term-proximity graph Δ for that document. Δ is a function of the term-proximity graph Γ and the document D, and can also be written as Δ(Γ,D). Thus, the construction of the relevancy context within D begins.

Step 103 represents the feedback from the relevancy context of Δ of the document D to the term-proximity graph Γ of the query. As a result of this feedback, the graph Γ is geometrized, i.e., its vertices receive masses and its edges receive local potentials, and the geometrized term-proximity graph, G, of document D is thus generated. G is a function of the term-proximity graph Γ and the document D, and can also be written as G(Γ,D). The total potential, P_{Γ}(D), is evaluated at this step.

Step 104 represents “enrichment” (e.g., term-saturation) of the geometrized term-proximity graph G with new vertices (e.g., new words with new masses, new edges and new potentials) resulting in the generation of a new geometrized term-proximity graph, G′(Γ,D).

Step 105 represents a geometric “mechanism” (e.g., term detection and condensation) of term formation: new terms may emerge as a result of combining vertices based on the specific geometric proportion of potentials and masses, resulting in the generation of a new geometrized term-proximity graph, G″(Γ,D).

Step 106 represents the new algorithm of documents grouping based on establishing patterns of geometric affinity of the geometrized term-proximity graphs of the involved documents. Based on the results of this highly efficient clustering, the original query is enhanced and refined along with the enhancement and refinement of its term-proximity graph.

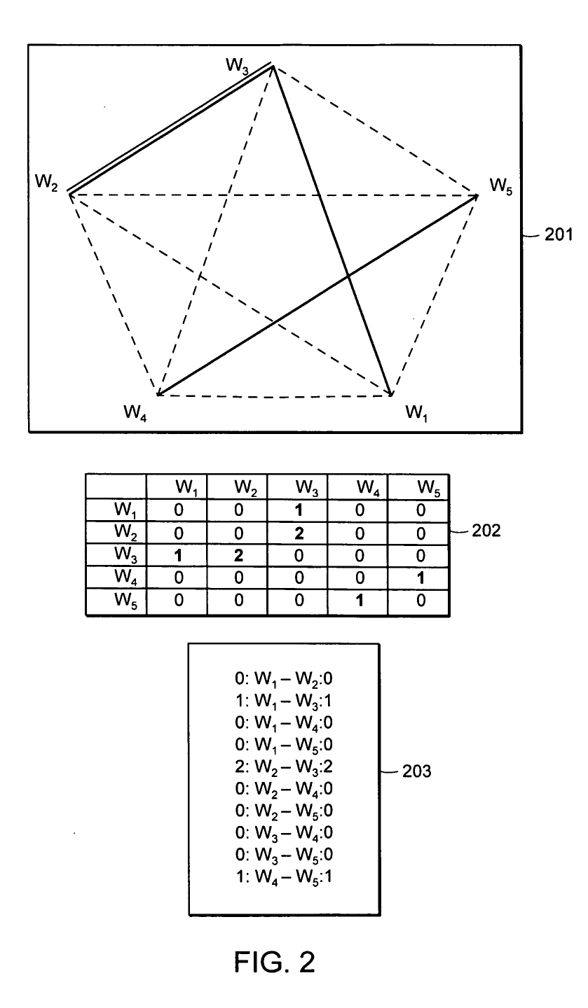

FIG. 2 represents three possible embodiments for the creation and representation of the term-proximity graph Γ of step 101 in FIG. 1. In this example, the user has entered a query consisting of five sets of symbols (referred to hereafter as words): W₁, W₂, W₃, W₄, and W₅. At the same time, the user has the option of explicitly assigning an expected degree of relationship between the words (e.g., the proximity of the query words within the retrieved documents). The proximity assigned between two query words W and W′ can be represented as a non-negative number mult(W, W′) and further referred to as the multiplicity.

Block 201 depicts a purely geometric approach to graph creation and representation. Each word W of a given query is represented by a vertex and each edge denotes proximity of the query words, wherein the proximity of an edge (W, W′) is the expected degree of relationship between W and W′ in those documents with which the term-proximity graph will match. The multiplicity, mult(W, W′), is assigned to the edge (W, W′). We will follow the convention that mult(W, W′)=0 if and only if the pair (W, W′) is not assigned by the user or system to be an edge, and mult(W, W) is the multiplicity of the vertex W, which is to be denoted as mult(W).In the example given in block 201, the user or system has assigned multiplicity values only between the word pairs (W₁, W₃), (W₂, W₃), and (W₄, W₅).

Block 202 depicts a matrix representation of the same term-proximity graph. The graph is now represented by an nxn matrix, where n is the number of words in the query (i.e., n is the number of vertices of the graph in block 201). A cell in the intersection of the i-th row and thej-th column contains a non-negative number that equals the multiplicity, mult(Wᵢ,Wⱼ).

Block 203 depicts the presentation of the same graph by a list of all pairs of the words of the query—total n² pairs. Each pair (Wᵢ,Wⱼ) is accompanied by two numbers: on the left, the multiplicity mult(Wⱼ,Wᵢ), and on the right—the multiplicity mult(Wᵢ,Wⱼ).

In each of the embodiments shown in FIG. 2, the user always has the option of not having to explicitly assign the multiplicities to the query words. In such a case, the user simply has to enter the query words into a prompt and a default multiplicity value will be assigned automatically, for example to the edges and vertices of block 201. This default value may be 1, but is not limited as such. In addition, each of the embodiments shown in FIG. 2 can mathematically be viewed as a discrete topological entity (i.e., topological search queries), in which the query is not simply a linear string of words, but a set of elements (e.g., search query words) with some level of connection defined between at least some of the elements.

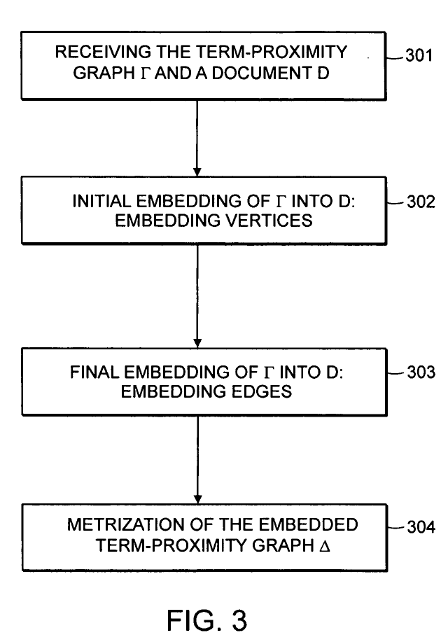

FIG. 3 represents one possible procedure for implementing step 102 of FIG. I for the generation of a metrized embedded term-proximity graph Δ for a document D.

Step 301 receives the term-proximity graph r and a document D.

Step 302 performs the initial embedding of Γ into D by recording all of the occurrences of each query word W, i.e., each vertex of Γ, in the document D. These occurrences are marked as (W, 1), (W, 2), . . . , (W, k), for the first, second, and kth occurrence, respectively, and generate the vertices of the embedded term-proximity graph Δ.

Step 303 finalizes the embedding Γ into D by creating edges of the embedded term-proximity graph Δ. Two occurrences, (W,i) of W and (W′,j) of W′, generate an edge ((W,i),(W′,j)) of Δ if two conditions are met: (i) the pair (W,W′) comprises an edge of Γ and (ii) the edge ((W,i), (W′,j)) is reduced, i.e., neither W nor W′ occurs in the document D between the words (W,i), (W′,j). The edge ((W,i),(W′,j)) can include at least some of the words that may separate the words (W,i) and (W′j), i.e., the edge can be a string of words between the two words comprising the vertices of the edge.

Step 304 performs the metrization of the embedded term-proximity graph Δ by assigning the value v((W,i), (W′,j)) to the edge ((W,i), (W′,j)) based on the formula
v((W,i), (W′,j))=1/dist((W,i), (W′,j)),
where the distance between any two words U and U′ in a document D can be defined in one embodiment by the formula
dist(U,U′)=(N+1)^{k}.(M+1),
where N is the number of terms in document D separating the words U and U′, M is the number of sentences in document D separating the words U and U′, and k is a positive number, e.g., M=0 if U and U′ belong to the same sentence and M=1 if U and U′ belong to consecutive sentences. It will be appreciated by those skilled in the art that the formula for the distance between two words can be defined in a broader manner by
dist(U,U′)=ƒ(S),
where ƒ(S) is any function of the set of real variables S such that ƒ(x)>0. The set S may include, but is not limited to, N, M, and k, as described above, in addition to any other variable representing the number of paragraphs, pages, sections, etc. in document D separating words U and U′. In the above example, S={N,M,k}, and ƒ(N,M,k)=g(N,k) h(M)=(N+1)^{k}.(M+1).

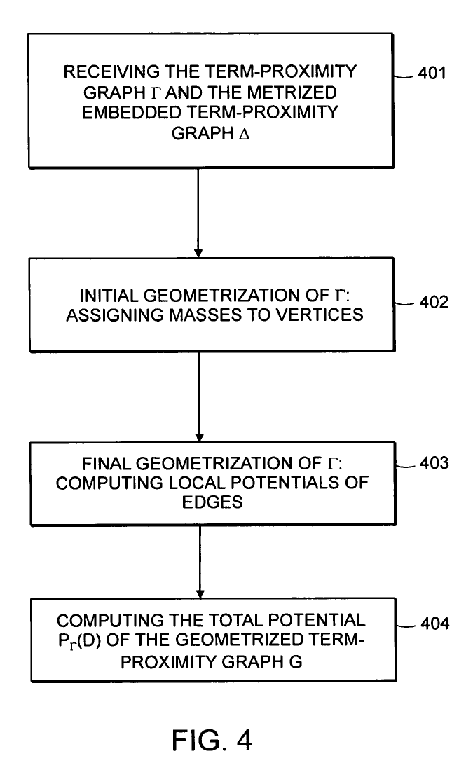

FIG. 4 represents one possible procedure for implementing step 103 of FIG. 1 for geometrizing the term-proximity graph Γ using the metrized embedded term-proximity graph Δ, resulting in the generation of the geometrization term-proximity graph G for document D, and the calculation of the total potential P_{Γ} (D) of the geometrized term-proximity graph.

Step 401 receives the term-proximity graph Γ and the metrized embedded term-proximity graph Δ of the document D.

In step 402, the initial geometrization of Γ, resulting in the generation of the geometrized term-proximity graph G, relative to Δ is performed. The graph G(Γ,D) is initially identical to the graph Γ. In this step, each vertex W of G is assigned a mass m_{W}, which is the number of vertices of the type W in the metrized embedded term-proximity graph Δ (i.e., m_{W} is the number of occurrences of the query term W in document D).

In step 403, the final geometrization of Γ relative to document D is performed by assigning to each edge (W,W′) of G a local potential P(W,W′)(D) relative to an edge (W,W′) of the term-proximity graph Γ is given by the formula
P_{(W,W′)}(D)=Συ((W,i), (W′,j)),
where the summation is over all edges of the metrized embedded term-proximity graph Δ of the type (W, W′), i.e., based on query words W and W′.

In step 404, the total potential P_{Γ}(D) of the geometrized term-proximity graph G(Γ,D) is computed by the formula
P_{Γ}(D)=Σ_{W}mult(W).m_{W}+Σ_{(W,W′)}mult(W,W′).P_{(W,W′)}(D),
where the first summation is over the all vertices of the geometrized term-proximity graph G (i.e., over all words of the query) and the second summation is over all the edges of G.

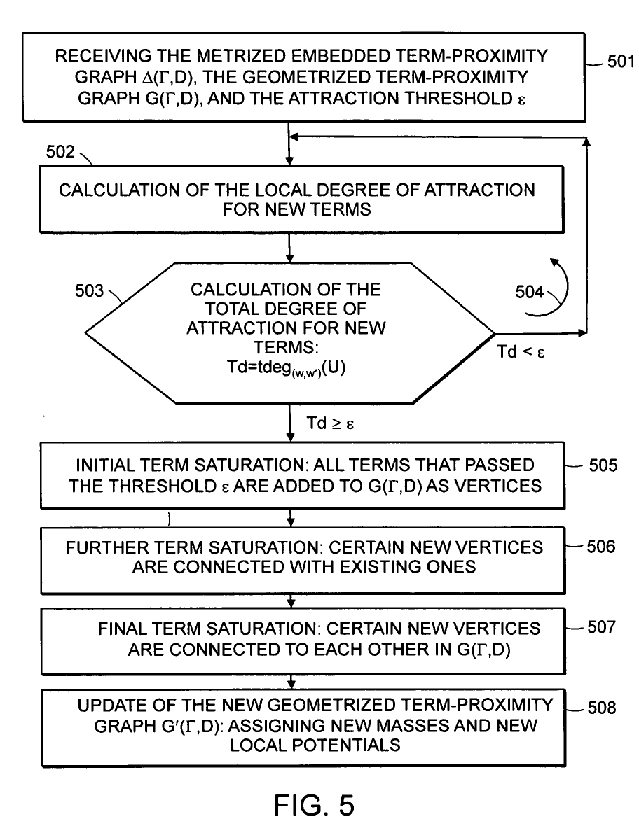

FIG. 5 represents one possible procedure for implementing step 104 of FIG. 1 for term-saturation of the geometrized term-proximity graph G.

Step 501 receives the document D, the metrized embedded term-proximity graph ΔA, the geometrized term-proximity graph G(Γ,D) relative to D, and an attraction threshold ε. The attraction threshold may be set by default or assigned a value by the user.

In step 502, for each occurrence (U, k) of a word U in document D, where k is the kth occurrence, a local degree of attraction, deg_{(W,W′)(U, k), is calculated as follows: deg}_{(W,W′)(U, k)=}0 if no edge of the metrized embedded term-proximity graph Δ of the type (W,W′) contains (U, k), i.e. the word U is not located between any two occurrences of the words (W,i) and (W′,j) where ((W,i), W′j)) comprise an edge of Δ, and:
deg_{(W,W′)}(U, k)=υ((W,i), (W′j)),
if ((W,i), (W′j)) is the only edge of the metrized embedded term proximity graph Δ that contains the occurrence of the word (U, k), i.e., the word (U, k) exists between the words (W,i) and (W′,j).

In step 503, each word U that occurs in document D receives a value, called the total degree of attraction, given by tdeg(W,W′)(U), which is given by the formula:

tdeg_{(W,W,)}(U)=Σdeg_{(W,W′)}(U, k)

where the summation is over all occurrences (U, k) of the word U in document D.

If the total degree of attraction is less than the attraction threshold, tdeg_{(W,W′)}(U)<ε, then the word U is not attracted by the edge (W,W′) and the loop 504 returns to step 502 for picking up a new word to determine if there exists an attraction by the edge (W,W′).

Otherwise, step 505 starts the initial term saturation by creating a new vertex in the geometrized term-proximity graph G(Γ,D) corresponding to the word U, wherien the word U is attracted by the edge (W,W′).

In step 506 the term saturation continues via creating edges of the form (U, W) and (U,W′), where U is a word of D attracted by the edge (W,W′). At this point, the procedure returns to step 502, unless there are no more terms to evaluate.

The final stage of the term saturation is performed in step 507. Two words U and U′ attracted by edge (W,W′) are connected in the geomtrized term-proximity graph G(Γ,D) if and only if both of the words U and U′ occur within an edge ((W,i), (W′,j)) in document D, i.e., both of the words U and U′ are located between the words (W,i) and (W′,j).

In step 508, the geometrized term-proximity graph is updated as G′(Γ,D) (or a new graph may be generated) via assignment of both the masses of new vertices and the local potentials of the new edges of the term-saturated geometrized term-proximity graph G′ according to the routines of FIG. 3 and FIG. 4. A total potential of the new geometrized term-proximity graph G′ can be calculated at this point to provide a new ranking list of the documents.

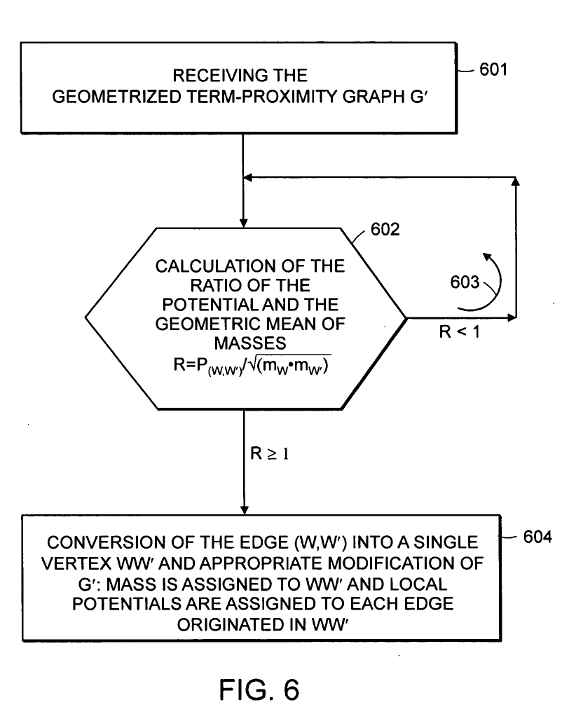

FIG. 6 represents one possible procedure for implementing step 105 of FIG. I for term-detection and condensation of the geometrized term-proximity graph G′.

Step 601 receives a geometrized term-proximity graph G′.

In step 602, the ratio P_{(W,W′)}/✓(m_{W}.m_{W′}) is calculated for each edge (W, W′) of G′.

If P_{(W,W′)}/✓(m_{W}.m_{W′})<1, then the edge (W, W′) is left unchanged and the loop 603 returns to step 602 for picking up another edge.

Otherwise, step 604 converts the edge (W, W′) into a term WW′ as follows. The edge (W,W′) is replaced by a single vertex WW′ and the following modification takes place:
(i) the multiplicity and the mass to the new vertex WW′ are computed by the formulae:
   mult(WW′)=mult(W)+mult(W′)+mult(W,W′) m_{WW′}=min(m_{W}, m_{W′})
(ii) the multiplicity and the local potential of each new edge of the form (WW′, W″), where W″ is any other vertex of the original term-proximity graph G′, are computed by the formulae:
   mult(WW′, W″)=mult(W,W″)+mult(W′,W″) P_{(WW′, W″)}=max(P_{(W,W″)},P_{(W′W″)}),
   where min(x,y) and max(x,y) refer to the minimum and maximum, respectively, of x or y.

A total potential of the new geometrized term-proximity graph G″ can be calculated at this point to provide a new ranking list of the documents.

FIG. 7 represents one possible procedure for implementing step 106 of FIG. 1 for clustering the documents and enhancing/refining the original term-proximity graph Γ, i.e., the query.

Step 701 receives a list of N documents D₁, D₂, . . . , D_{N} with their respective geometrized term-proximity graphs G(D₁), G(D₂), . . . , G(D_{N}), where the documents are ordered according to their total potentials: P(D₁)≧P(D₂)≧. . . ≧P(D_{N}). The geometrized term-proximity graphs used may be taken either after step 103, step 104, or step 105.

In step 702, the geometrized term-proximity graph G(D₁) of the document D₁ is matched with the geometrized term proximity graphs G(D₂), . . . , G(D_{N}), and the respective degrees of affinity d_{1,2}, d_{1,3}, . . . , d_{1,N}, are calculated, where the degree of affinity dᵢⱼ between geometrized graphs G(Dᵢ) and G(Dⱼ) is calculated based on term matching between the respective vertices of the graphs as follows:

dᵢⱼ=Σ_{k,l}#([Uₖ]∩[Wₗ]−[Q]).(pₖ+qₗ),

where Uₖ is a k-th vertex of G(Dᵢ) and Wₗ is a l-th vertex of G(Dⱼ), [Uₖ] is the set of words in the term Uₖ and [Wₗ] is the set of words in the term Wₗ, [Q] is the set of words of the query, the symbol “∩” stands for an intersection of two sets, the symbol “—” stands for the difference between two sets, the symbol “#” denotes the number elements in a set; pₖ is the total potential of the star generated by the vertex Uₖ in the graph G(Dᵢ), (i.e., where a star around a vertex of a graph is the sub-graph which contains this vertex and all vertices directly connected to it), and qₗ is the total potential of the star generated by the vertex Wₗ in the graph G(Dⱼ).

Step 703 forms the first cluster out of the document Dₗ and all those documents in which the degree of affinity is at least 1/10, for example, the average of all of the degrees of affinity, and orders the documents in the cluster according to their degrees of affinity: D₁, D′₂, . . . , D′_{K.}

Other clusters can be formed by repeating the routines of blocks 701-703 for the remaining documents.

In step 704, an enhanced term-proximity graph Γ′ is generated by incorporating new terms into the term-proximity graph Γ which contributed to formation of a given cluster, e.g., these terms can be the terms whose contribution to the formula dᵢⱼ=Σ_{k,l}# ([U_{k]∩[W}ₗ]−[Q]).(pₖ+qₗ) is not zero, i.e., those terms that belong to the set [Uₖ]∩[Wₗ]−[Q] in step 702. The vertices of the graph Γ′ form the new query.

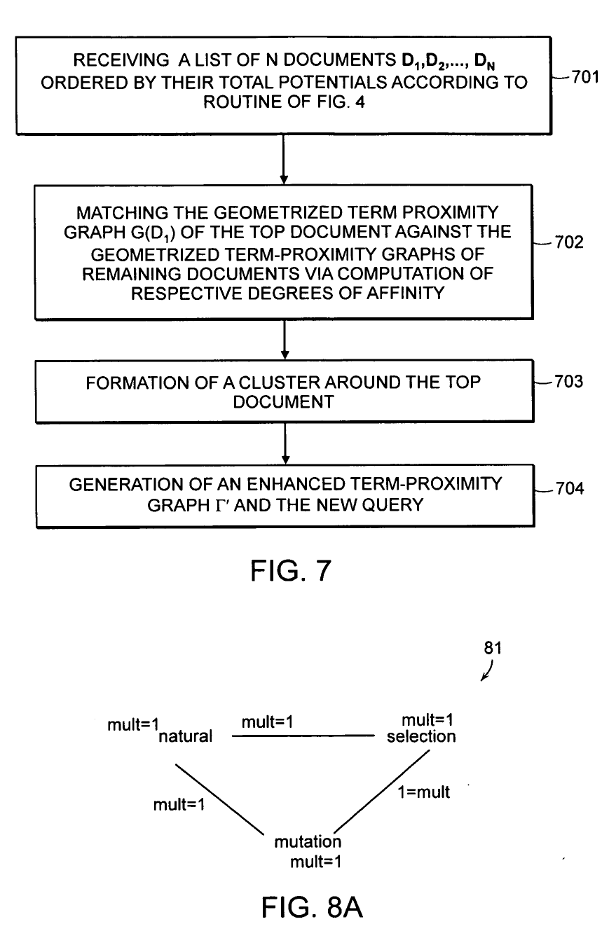

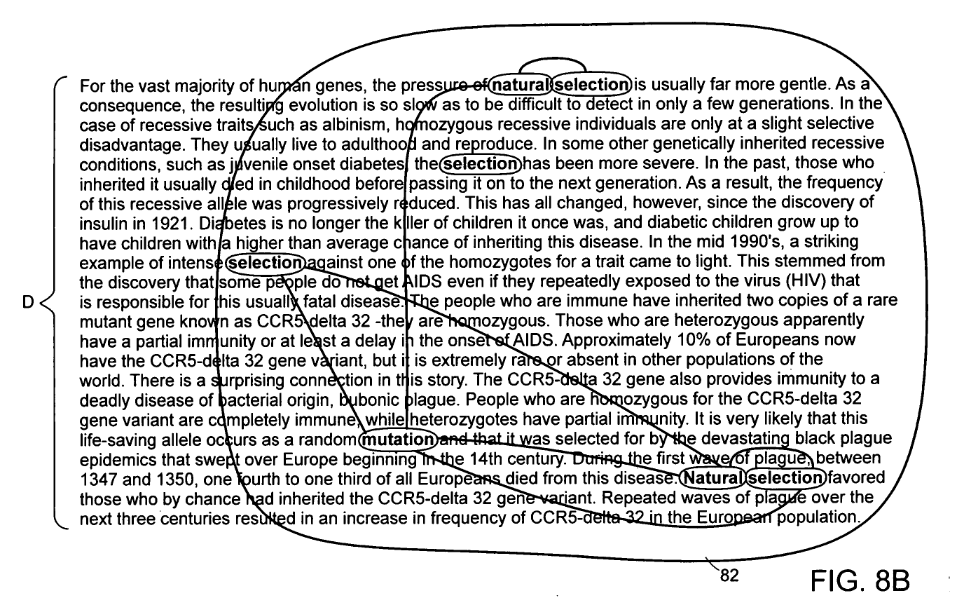

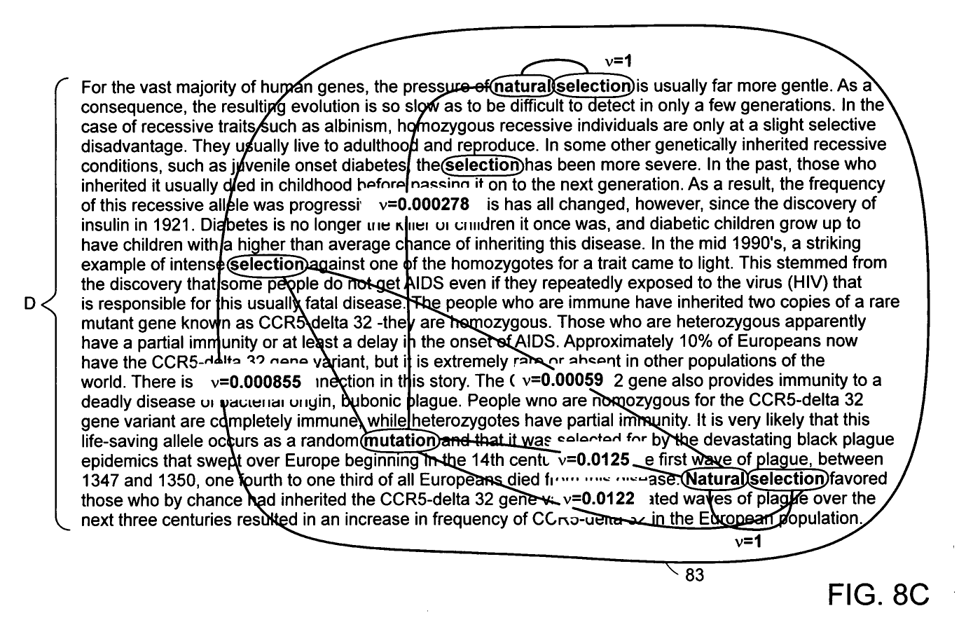

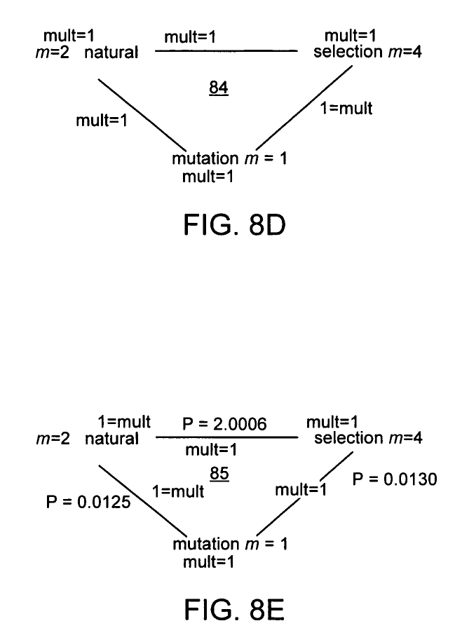

FIGS. 8A-8E is an example of a method for generating a nonlinear representation for a document D given a query Q. In this example, a user has entered the search query “natural selection mutation” and the multiplicities have been given a default value of 1. FIG. 8A represents the generated term-proximity graph 81, wherein the three query terms comprise the three vertices of 81. In addition, each edge and vertex has been assigned a multiplicity value of 1. FIG. 8B represents a generated embedded term-proximity graph 82 for a given document D and a given term-proximity graph 81. FIG. 8C represents a generated metrized embedded term-proximity graph 83 for a given document D and a given term proximity graph 81. Each edge has been assigned a value v, described in step 304. FIG. 8D represents the first step in the generation of a geometrized term-proximity graph 84, wherein masses have been assigned to the vertices. FIG. 8E represents the second step in the generated geometrized term-proximity graph 85, wherein local potentials P have been assigned to each edge. Given 85, the total potential of the document with respect to the initial query 81 can be calculated by the formula
P_{Γ}(D)=Σ_{W}mult(W).m_{W}+Σ_{(W,W′)}mult(W,W′).P_{(W,W′)}(D).
The total potential for the given example 85 is therefore calculated to be 9.0264. In this example, it is seen that the local potentials of most of the edges contribute little to the total potential, i.e., the vertices overwhelmingly contribute to the total potential. It may be preferred, in such cases, to have the default multiplicity values of the vertices be initially set to a smaller value, for example 0.002, such that the total potential would instead result in a value of 2.0404, which is more of a measure of the proximity of the terms (i.e., the local potentials of the edges) rather than the frequency of their occurrence (i.e., the masses of the vertices). By performing this method on other documents, a total potential, i.e., ranking value, is obtained to order the documents. The above-described techniques can be implemented in digital electronic circuitry, or in computer hardware, firmware, software, or in combinations of them. The implementation can be as a computer program product, i.e., a computer program tangibly embodied in an information carrier, e.g., in a machine-readable storage device or in a propagated signal, for execution by, or to control the operation of, data processing apparatus, e.g., a programmable processor, a computer, or multiple computers.

A computer program can be written in any form of programming language, including compiled or interpreted languages, and it can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps can be performed by one or more programmable processors executing a computer program to perform functions of the invention by operating on input data and generating output. Method steps can also be performed by, and apparatus can be implemented as, special purpose logic circuitry, e.g., an FPGA (field programmable gate array) or an ASIC (application specific integrated circuit). Modules can refer to portions of the computer program and/or the processor/special circuitry that implements that functionality.

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. Data transmission and instructions can also occur over a communications network.

Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in special purpose logic circuitry.

The terms “module” and “function,” as used herein, mean, but are not limited to, a software or hardware component which performs certain tasks. A module may advantageously be configured to reside on addressable storage medium and configured to execute on one or more processors. A module may be fully or partially implemented with a general purpose integrated circuit (IC), FPGA, or ASIC. Thus, a module may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables. The functionality provided for in the components and modules may be combined into fewer components and modules or further separated into additional components and modules.

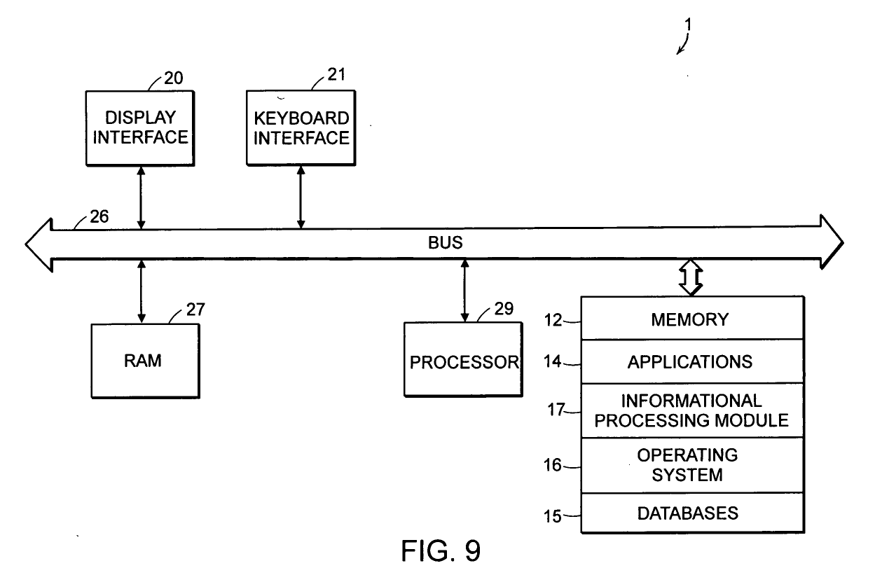

FIG. 9 shows the internal structure of a digital computer 1 as described above. Computer 1 can include mass storage 12, which comprises a computer-readable medium such as a computer hard disk and/or RAID (“redundant array of inexpensive disks”). Mass storage 12 is adapted to store applications 14, databases 15, and operating systems 16. In preferred embodiments of the invention, the operating system 16 is a windowing operating system, such as RedHat® Linux or Microsoft.® Windows98, although the invention may be used with other operating systems as well. Among the applications stored in memory 12 is an informational processing module 17 and document files. The informational processing module 17 processes the document files to create the output generated by embodiments of the present invention. Computer 1 can also include display interface 20, keyboard interface 21, computer bus 26, RAM 27, and processor 29. Processor 29 preferably comprises a Pentium Il® (Intel Corporation, Santa Clara, Calif.) microprocessor or the like for executing applications. Such applications, including the informational processing module and/or embodiments of the present invention 17, may be stored in memory 12 (as above). Processor 29 accesses applications (or other data) stored in memory 12 via bus 26. Application execution and other tasks of Computer 1 may be initiated using keyboard 6 commands from which are transmitted to processor 29 via keyboard interface 21. Output results from applications running on Computer I may be processed by display interface 20 and then displayed to a user on display 5.

While this invention has been particularly shown and described with references to preferred embodiments thereof, it will be understood by those skilled in the art that various changes in form and details may be made therein without departing from the scope of the invention encompassed by the appended claims.

What is claimed is:

1. A method for processing a document in a set of documents, comprising the steps of:
generating a topological search query comprising a set of search terms having a defined interrelationship between at least two of the terms; and
generating a non-linear representation for at least one document in the set based on the topological search query, the nonlinear representation representing a measure of at least proximity of the search terms within the document.

2. The method of claim 1 further comprising the step of calculating a ranking value for the document based on proximity information in the non-linear representation of the corresponding document.

3. The method of claim 1 further comprising the step of refining the topological search query based on extracting new terms using the non-linear representation of a corresponding document.

4. The method of claim 1 further comprising the step of processing information in at least two or more non-linear representations of corresponding documents to generate a cluster of the documents.

5. An apparatus for processing a document in a set of documents, comprising:
means for generating a topological search query comprising a set of search terms having a defined interrelationship between at least two of the terms; and
means for generating a non-linear representation for at least one document in the set based on the topological search query, the nonlinear representation representing a measure of at least proximity of the search terms within the document.
